(19) United States
(12) Patent Application Publication
(10) Pub. No.: US 2025/0037307 A1
(43) Pub. Date: Jan. 30, 2025

(54) Devices and Methods for Computer Vision Guided Analysis of a Display Module

(71) Applicant: ZEBRA TECHNOLOGIES CORPORATION, Lincolnshire, IL (US)

(72) Inventors: Andrea Bordone Molini, London (GB); Andrea Mirabile, London (GB)

(21) Appl. No.: 18/226,934

(22) Filed: Jul. 27, 2023

(51) Int. Cl. G06T 7/73; G06K 7/14; G06T 3/40; G06T 7/33

(52) U.S. Cl. CPC G06T 7/74; G06K 7/1417; G06T 3/4053; G06T 7/337; G06T 2207/10016; G06T 2207/20081; G06T 2207/20084

(57) ABSTRACT

Devices and methods for computer vision guided analysis of a display module are disclosed herein. The method captures a burst of images of at least a portion of an object for displaying at least one item. The method detects at least one attribute of the object present in a first image of the burst of images and extracts the at least one attribute of the object present in the first image from each image of the burst of images. The method aligns the extracted at least one attribute from each image of the burst of images with the extracted at least one attribute of the first image and generates a reconstructed image based on the aligned at least one attribute of the burst of images where the resolution of the first image is different from the resolution of the reconstructed image.

### BACKGROUND

A facility (e.g., a grocery store, a convenience store, a retail store, etc.) can include at least one support structure (e.g., a display module) with one or more support surfaces (e.g., shelves) for carrying and displaying one or more items. For example, items can be faced on a display module such that the items are positioned on a front edge of a support surface of the display module and oriented to be identifiable (e.g., an associate or customer can observe an item identifier such as a name, logo and/or slogan and/or an item is associated and aligned with a label of a support surface such as a Stock Keeping Unit (SKU) or a product code). An associate of a facility can utilize a device (e.g., a mobile computer, tablet, barcode scanner, etc.) to identify each item displayed on a display module. For example, an associate can scan each item and/or process an associated label thereof (e.g., scan a SKU or a product code). Additionally, based on the identification, an associate can perform other tasks including, but not limited to, locating, picking, and/or re-stocking each item displayed on a display module.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of a system of the present disclosure.

FIG. 2 is a diagram illustrating components of the computing device of FIG. 1.

FIG. 3 is a flowchart illustrating processing steps carried out by an embodiment of the present disclosure.

FIGS. 4A-B are diagrams illustrating processing steps carried out by an embodiment of the present disclosure.

FIG. 5 is a diagram illustrating portions of an extracted at least one attribute of an object present in a burst of images and a portion of a reconstructed image based on the extracted and aligned at least one attribute of the burst of images.

FIG. 6 is a diagram illustrating a comparison of a portion of an extracted at least one attribute of an object present in a burst of images and a portion of a reconstructed image.

FIG. 7 is a diagram illustrating a comparison of a portion of an extracted at least one attribute of an object present in a burst of images and a portion of a reconstructed image.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned above, an associate of a facility can utilize a device (e.g., a mobile computer, tablet, barcode scanner, etc.) to identify each item displayed on a display module. For example, an associate can scan each item and/or process an associated label thereof (e.g., scan a SKU or a product code). Additionally, based on the identification, an associate can perform other tasks including, but not limited to, locating, picking, and/or re-stocking each item displayed on a display module.

Scanning each item is a manual process (e.g., relies on human intervention) and, as such, can be time-consuming, cost-prohibitive (e.g., increased associate labor costs), and subject to human error (e.g., scanning an incorrect item and/or associated label). For example, it can be time-consuming to manually analyze each display module of a facility and scan each item and/or label thereof to identify each item, locate each item, pick each item and/or determine whether each item requires re-stocking. It can also be challenging for an associate to scan a correct item and/or label of interest based on a state (e.g., a degree of unorganization) of a display module.

Conventional systems for identifying at least one item of a display module based on a captured image can utilize high-resolution imaging systems that are cost-prohibitive to deploy and utilize in a facility. For example, these systems can require high-resolution camera systems to capture an entirety of a display module with sufficient quality (e.g., sufficient detail) due to a substantial distance between the camera systems and the display module. Alternatively, other conventional systems for identifying at least one item of a display module based on a captured image can utilize low-resolution imaging systems. However, these systems can utilize low-resolution camera systems and, as such, can provide captured images of an entirety of a display module that are of insufficient quality (e.g., insufficient detail) due to a substantial distance between the camera systems and the display module.

As such, conventional systems suffer from a general lack of versatility because these systems cannot automatically and dynamically generate a reconstructed image based on a captured burst of images of at least a portion of a display module and detect at least one attribute (e.g., a barcode, feature and/or text) present in the reconstructed image with sufficient detail where the resolution of the reconstructed image is greater than the resolution of the burst of images.

Overall, this lack of versatility causes conventional systems to provide underwhelming performance and reduce the efficiency and general timeliness of performing facility tasks. Thus, it is an objective of the present disclosure to eliminate these and other problems with conventional systems and methods via systems and methods that can automatically and dynamically generate a reconstructed image based on a captured burst of images of at least a portion of a display module and detect at least one attribute (e.g., a barcode, feature and/or text) present in the reconstructed image with sufficient detail where the resolution of the reconstructed image is greater than the resolution of the burst of images.

In accordance with the above, and with the disclosure herein, the present disclosure includes improvements in computer functionality or in improvements to other technologies at least because the present disclosure describes that, e.g., information systems, and their related various components, may be improved or enhanced with the disclosed dynamic system features and methods that provide more efficient workflows for workers and improved management of display modules and planograms thereof for system administrators. That is, the present disclosure describes improvements in the functioning of an information system itself or “any other technology or technical field” (e.g., the field of distributed and/or commercial information systems). For example, the disclosed dynamic system features and methods improve and enhance the generation of a reconstructed image based on a captured burst of images of at least a portion of a display module and the detection of at least one attribute (e.g., a barcode, feature and/or text) present in the reconstructed image with sufficient detail where the resolution of the reconstructed image is greater than the resolution of the burst of images. This mitigates (if not eliminates) worker error and eliminates inefficiencies typically experienced over time by systems lacking such features and methods. This improves the state of the art at least because such previous systems are inefficient as they lack the ability to automatically and dynamically generate a reconstructed image based on a captured burst of images of at least a portion of a display module and detect at least one attribute present in the reconstructed image with sufficient detail (e.g., a barcode, feature and/or text) where the resolution of the reconstructed image is greater than the resolution of the burst of images. In this way, the system obviates manually analyzing each display module of a facility and scanning each item and/or label thereof to identify each item. Additionally, the system facilitates, based on the identification of each item, performing other tasks including, but not limited to, locating, picking, and/or re-stocking each item displayed on a display module.

The present disclosure also applies various features and functionality, as described herein, with, or by use of, a particular machine, e.g., a processor, a mobile device (e.g., a phone, a tablet, a mobile computer, a barcode scanner, a wearable or camera) and/or other hardware components as described herein. Moreover, the present disclosure includes specific features other than what is well-understood, routine, conventional activity in the field, or adds unconventional steps that demonstrate, in various embodiments, particular useful applications, e.g., generating a reconstructed image based on a captured burst of images of at least a portion of a display module and detecting at least one attribute (e.g., a barcode, feature and/or text) present in the reconstructed image with sufficient detail where the resolution of the reconstructed image is greater than the resolution of the burst of images.

Accordingly, it would be highly beneficial to develop a system and method that can automatically and dynamically generate a reconstructed image based on a captured burst of images of at least a portion of a display module and detect at least one attribute (e.g., a barcode, feature and/or text) present in the reconstructed image with sufficient detail where the resolution of the reconstructed image is greater than the resolution of the burst of images. In this way, the system obviates manually analyzing each display module of a facility and scanning each item and/or label thereof to identify each item. Additionally, the system facilitates, based on the identification of each item, performing other tasks including, but not limited to, locating, picking, and/or re-stocking each item displayed on a display module. The devices and methods of the present disclosure address these and other needs.

In an embodiment, the present disclosure is directed to a method. The method comprises: capturing a burst of images of at least a portion of an object, the object being a display module for displaying at least one item; detecting at least one attribute of the object present in a first image of the burst of images; extracting the at least one attribute of the object present in the first image from each image of the burst of images; aligning the extracted at least one attribute from each image of the burst of images with the extracted at least one attribute of the first image; and generating a reconstructed image based on the aligned at least one attribute of the burst of images, where the resolution of the first image is different from the resolution of the reconstructed image.

In an embodiment, the present disclosure is directed to a device comprising an imaging assembly configured to capture a burst of images of at least a portion of an object where the object is a display module for displaying at least one item; one or more processors; and a non-transitory computer-readable memory coupled to the imaging assembly and the one or more processors. The memory stores instructions thereon that, when executed by the one or more processors, cause the one or more processors to: detect at least one attribute of the object present in a first image of the burst of images, extract the at least one attribute of the object present in the first image from each image of the burst of images, align the extracted at least one attribute from each image of the burst of images with the extracted at least one attribute of the first image, and generate a reconstructed image based on the aligned at least one attribute of the burst of images, where the resolution of the first image is different from the resolution of the reconstructed image.

In an embodiment, the present disclosure is directed to a system. The system comprises at least one device having an imaging assembly configured to capture a burst of images of at least a portion of an object where the object is a display module for displaying at least one item; a server having one or more processors; and a non-transitory computer-readable memory coupled to the server and the one or more processors. The memory stores instructions thereon that, when executed by the one or more processors, cause the one or more processors to: detect at least one attribute of the object present in a first image of the burst of images, extract the at least one attribute of the object present in the first image from each image of the burst of images, align the extracted at least one attribute from each image of the burst of images with the extracted at least one attribute of the first image, and generate a reconstructed image based on the aligned at least one attribute of the burst of images, where the resolution of the first image is different from the resolution of the reconstructed image.

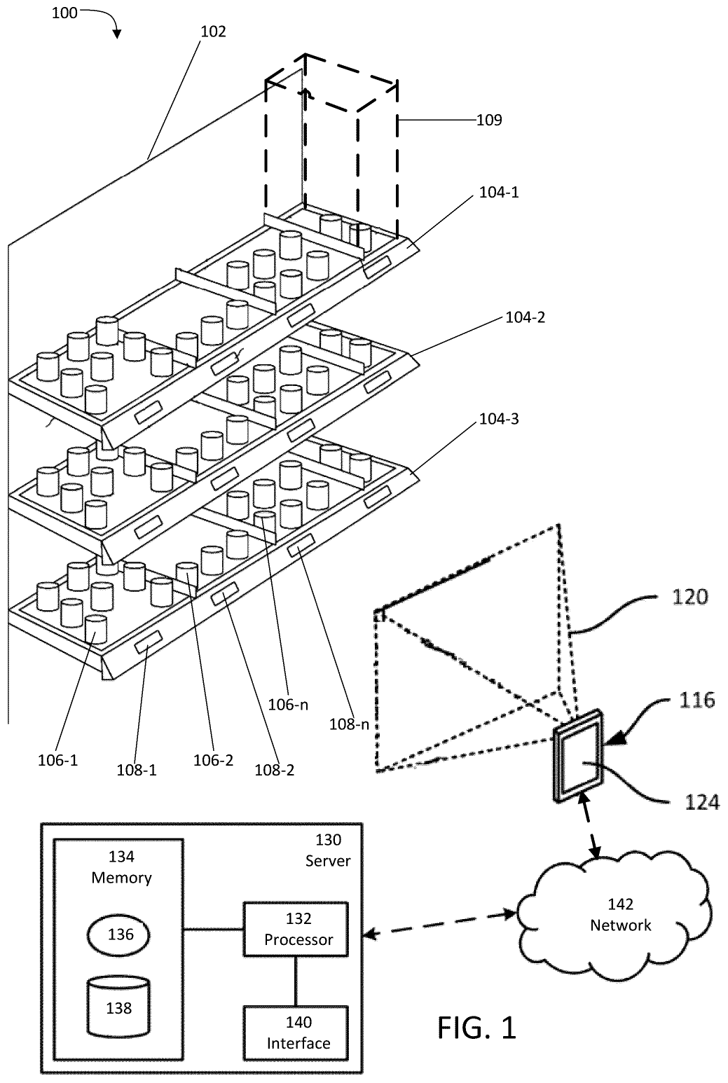

Turning to the Drawings, FIG. 1 is a diagram 100 illustrating an embodiment of a system of the present disclosure. FIG. 1 illustrates a system for dynamic display module analysis. The system can be deployed in a facility (e.g., a grocery store, a convenience store, a retail store, etc.). For example, the system can be deployed in a customer-accessible portion of the facility that may be referred to as the front of the facility.

Items received at the facility, e.g. via a receiving bay or the like, are generally positioned on a support structure (e.g., a display module) with one or more support surfaces (e.g., shelves) in a stock room, until restocking of the relevant items is required in the front of the facility. An associate can retrieve the items requiring restocking from the stock room, and transport those items to the appropriate locations in the front of the facility. Locations for items in the front of the facility are typically predetermined, e.g. according to a planogram that specifies, for each portion of shelving or other support structures, which items are to be positioned on such structures. The planogram can be accessed from a mobile device operated by the associate, kept on a printed sheet or the like.

A display module can become unorganized and/or depleted (e.g., an item becomes out of stock) which can result in lost sales because customers cannot locate items of interest. As mentioned above, an associate of a facility can utilize a device (e.g., a mobile computer, tablet, barcode scanner, etc.) to identify each item displayed on a display module. For example, an associate can scan each item and/or process an associated label thereof (e.g., scan a SKU or a product code). Additionally, based on the identification, an associate can perform other tasks including, but not limited to, locating, picking, and/or re-stocking each item displayed on a display module. Scanning each item is a manual process (e.g., relies on human intervention) and, as such, can be time-consuming, cost-prohibitive (e.g., increased associate labor costs), and subject to human error (e.g., scanning an incorrect item and/or associated label).

For example, it can be time-consuming to manually analyze each display module of a facility and scan each item and/or label thereof to identify each item, locate each item, pick each item and/or determine whether each item requires re-stocking. It can also be challenging for an associate to scan a correct item and/or label of interest based on a state (e.g., a degree of unorganization) of a display module. The system provides for automatically and dynamically generating a reconstructed image based on a captured burst of images of at least a portion of a display module and detecting at least one attribute (e.g., a barcode, feature and/or text) present in the reconstructed image with sufficient detail because the resolution of the reconstructed image is greater than the resolution of the burst of images. In this way, the system obviates manually analyzing each display module of a facility and scanning each item and/or label thereof to identify each item (e.g., to locate an item, pick an item and/or determine whether an item requires re-stocking).

As shown in FIG. 1, the facility includes at least one support structure such as a display module 102 with one or more support surfaces 104-1, 104-2, and 104-3 (collectively referred to as support surfaces 104, and generically referred to as support surface 104) carrying and displaying items 106-1, 106-2, and 106-n (collectively referred to as items 106, and generically referred to as item 106). The items 106 may be of different types such that item 106-1 is different from items 106-2 and 106-n, item 106-2 is different from item 106-n, etc. In addition, an item 106 can comprise one or more items. For example, item 106-1 comprises a group of eight items 106-1 and item 106-2 comprises a group of three items 106-2. Items 106-1, 106-2 and 106-3 can be respectively identified by item labels 108-1, 108-2 and 108-n (collectively referred to as labels 108, and generically referred to as label 108). For example, the label 108 can be a SKU and/or product code (e.g. a Universal Product Code (UPC)) or the like. A planogram can specify an item area 109 (e.g., of a support surface 104) indicative of a position of an item 106. An item area 109 can be determined relative to an alignment of a label 108 (e.g., left, right or center-aligned).

The system can include a device 116 (e.g., a phone, a tablet computer, a mobile computer, a barcode scanner, a wearable or the like). The device 116 can be operated by an associate at the facility, and includes an imaging assembly (e.g., a camera) having a field of view (FOV) 120 and a display 124. The device 116 can be manipulated such that the imaging assembly can view at least a portion of the display module 102 within the FOV 120 and can be configured to capture a burst of images of the display module 102. From the burst of images, the device 116 can detect and extract at least one attribute (e.g., a shape, a color, a pattern, a logo, a size, a width, a length, a height, and a label) of the display module 102 and/or an item positioned thereon.

Certain components of a server 130 are also illustrated in FIG. 1. The server 130 can include a processor 132 (e.g. one or more central processing units (CPUs)), interconnected with a non-transitory computer readable storage medium, such as a memory 134 and an interface 140. The memory 134 includes a combination of volatile memory (e.g. Random Access Memory or RAM) and non-volatile memory (e.g. read only memory or ROM, Electrically Erasable Programmable Read Only Memory or EEPROM, flash memory). The processor 132 and the memory 134 each comprise one or more integrated circuits.

The memory 134 stores computer readable instructions for execution by the processor 132. The memory 134 stores an analysis application 136 (also referred to simply as the application 136) which, when executed by the processor 132, configures the processor 132 to perform various functions described below in greater detail and related to automatically and dynamically detecting at least one attribute of an object present in a first image of the burst of images; extracting the at least one attribute of the object present in the first image from each image of the burst of images; aligning the extracted at least one attribute from each image of the burst of images with the extracted at least one attribute of the first image; and generating a reconstructed image based on the aligned at least one attribute of the burst of images, where the resolution of the first image is different from the resolution of the reconstructed image. In this way, the processor provides for automatically and dynamically generating a reconstructed image based on a captured burst of images of at least a portion of a display module and detecting at least one attribute (e.g., a barcode, feature and/or text) present in the reconstructed image with sufficient detail because the resolution of the reconstructed image is greater than the resolution of the burst of images. As described below, this functionality can also be executed by the processor 202 of the device 116.

The application 136 may also be implemented as a suite of distinct applications in other examples. Those skilled in the art will appreciate that the functionality implemented by the processor 132 via the execution of the application 136 may also be implemented by one or more specially designed hardware and firmware components, such as field-programmable gate arrays (FPGAs), application-specific integrated circuits (ASICs) and the like in other embodiments.

The server 130 also includes a communications interface 140 enabling the server 130 to communicate with other computing devices, including the device 116, via the network 142. The communications interface 140 includes suitable hardware elements (e.g. transceivers, ports and the like) and corresponding firmware according to the communications technology employed by the network 142.

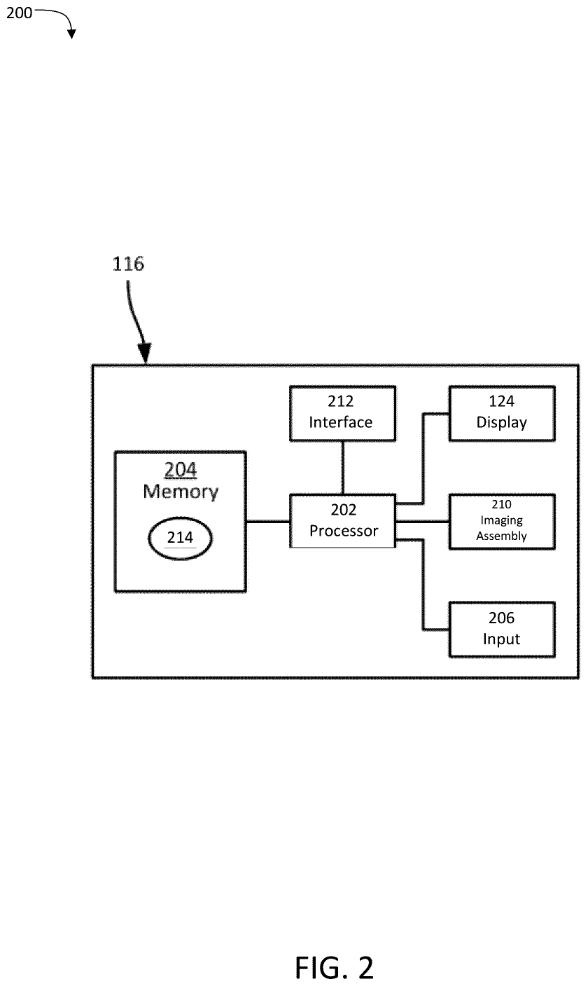

FIG. 2 is a diagram 200 illustrating components of the device 116 of FIG. 1. The device 116 includes a processor 202 (e.g. one or more CPUs), interconnected with a non-transitory computer readable storage medium, such as a memory 204, an input 206, a display 124, an imaging assembly 210, and an interface 212. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 202 and the memory 204 each comprise one or more integrated circuits.

The at least one input 206 can be a device interconnected with the processor 202. The input device 206 is configured to receive an input (e.g. from an operator of the device 116) and provide data representative of the received input to the processor 202. The input device 206 can include any one of, or a suitable combination of, a touch screen integrated with the display 124, a keypad, a microphone, a barcode scanner and the like. For example, an operator can utilize a barcode scanner to scan a label 108.

The imaging assembly 210 (e.g., a camera) includes a suitable image sensor or combination of image sensors. As mentioned above, the device 116 can be an imaging assembly (e.g., a camera). The camera 210 is configured to capture a burst of images for provision to the processor 202 and subsequent processing to detect and extract at least one attribute (e.g., a shape, a color, a pattern, a logo, a size, a width, a length, a height, and a label) of the display module 102 and/or an item 106 positioned thereon. For example, the processor 202 can generate a reconstructed image based on a captured burst of images of at least a portion of a display module 102 and detect at least one attribute (e.g., a barcode, feature and/or text) present in the reconstructed image with sufficient detail where the resolution of the reconstructed image is greater than the resolution of the burst of images.

As such, the camera 210 of the device 116 or the device 116 need not be a high-resolution camera or a system of high-resolution cameras to decode a label 108 from a captured image because the processor 202 can automatically and dynamically detect at least one attribute (e.g., a label) of an object present in a first image of the burst of images; extract the at least one attribute of the object present in the first image from each image of the burst of images; align the extracted at least one attribute from each image of the burst of images with the extracted at least one attribute of the first image; and generate a reconstructed image based on the aligned at least one attribute of the burst of images, where the resolution of the first image is different from the resolution of the reconstructed image.

In addition to the display 124, the device 116 can also include one or more other output devices, such as a speaker, a notification light-emitting diode (LED), and the like (not shown). The communications interface 212 enables the device 116 to communicate with other computing devices, such as the server 130, via the network 142. The interface 212 therefore includes a suitable combination of hardware elements (e.g. transceivers, antenna elements and the like) and accompanying firmware to enable such communication.

The memory 204 stores computer readable instructions for execution by the processor 202. In particular, the memory 204 stores an analysis application 214 (also referred to simply as the application 214) which, when executed by the processor 202, configures the processor 202 to perform various functions discussed below in greater detail and related to automatically and dynamically generating a reconstructed image based on a captured burst of images of at least a portion of a display module and detecting at least one attribute present in the reconstructed image with sufficient detail (e.g., a barcode, feature and/or text) because the resolution of the reconstructed image is greater than the resolution of the burst of images. The application 214 may also be implemented as a suite of distinct applications in other examples. Those skilled in the art will appreciate that the functionality implemented by the processor 202 via the execution of the application 214 may also be implemented by one or more specially designed hardware and firmware components, such as FPGAs, ASICs and the like in other embodiments. As noted above, in some examples the memory 204 can also store the repository 138, rather than the repository 138 being stored at the server 130.

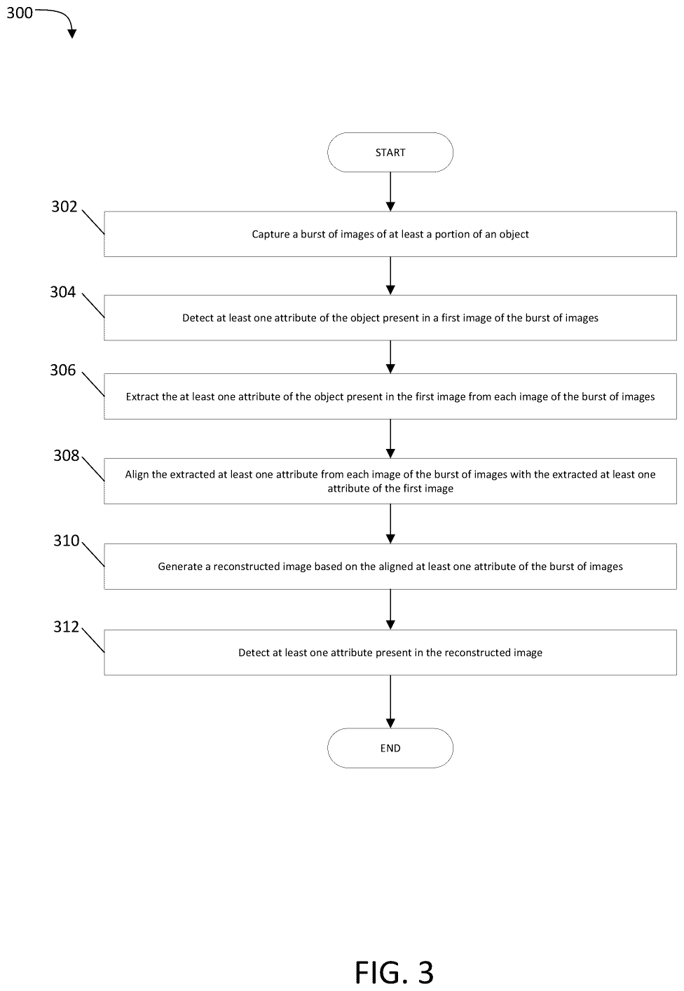

FIG. 3 is a flowchart 300 illustrating processing steps carried out by an embodiment of the present disclosure. The processing steps will be described in conjunction with their performance in the system (e.g., by the device 116 or the server 130 in conjunction with the device 116). In general, via performance of the processing steps, the system can automatically and dynamically generate a reconstructed image based on a captured burst of images of at least a portion of a display module and detect at least one attribute present in the reconstructed image with sufficient detail (e.g., a barcode, feature and/or text) because the resolution of the reconstructed image is greater than the resolution of the burst of images.

Referring to FIG. 3, in step 302, the system captures a burst of images of at least a portion of an object (e.g., a display module 102 and/or an item 106) where the burst of images is of low resolution. For example, the system can capture an image via the camera 210 of the device 116 by manipulating the camera 210 such that a FOV of the camera 210 includes at least a portion of the display module 102 including at least one item 106 and at least one label 108. The system can capture a burst of images when a display module 102 is likely to be organized and/or re-stocked (e.g., when a display module 102 does not interface with customers). The system can also capture a burst of images when a display module 102 is unorganized and/or depleted. In another example, an associate can capture a burst of images and the system can exploit a natural hand tremor of the associate to obtain misaligned images having additional information that the system can utilize to generate a reconstructed image.

In step 304, the system detects at least one attribute (e.g., a shape, a color, a pattern, a logo, a size, a width, a length, a height, and a label 108) of the display module 102 and/or an item 106 positioned thereon present in a first image of the burst of images. For example, the system can apply a localizer to one low resolution image of the burst of low resolution images to detect at least one label 108 associated with an item 106 where the label 108 depicts at least one of a barcode, feature and/or text (e.g., a price). Then, in step 306, the system extracts the at least one attribute of the display module 102 and/or item 106 present in the first image from each image of the burst of images. For example, the localizer can generate coordinates associated with the at least one attribute of the display module 102 and/or item 106 and the system can utilize the coordinates to extract (e.g., crop) the at least one attribute present in the first image from each image of the burst of images.

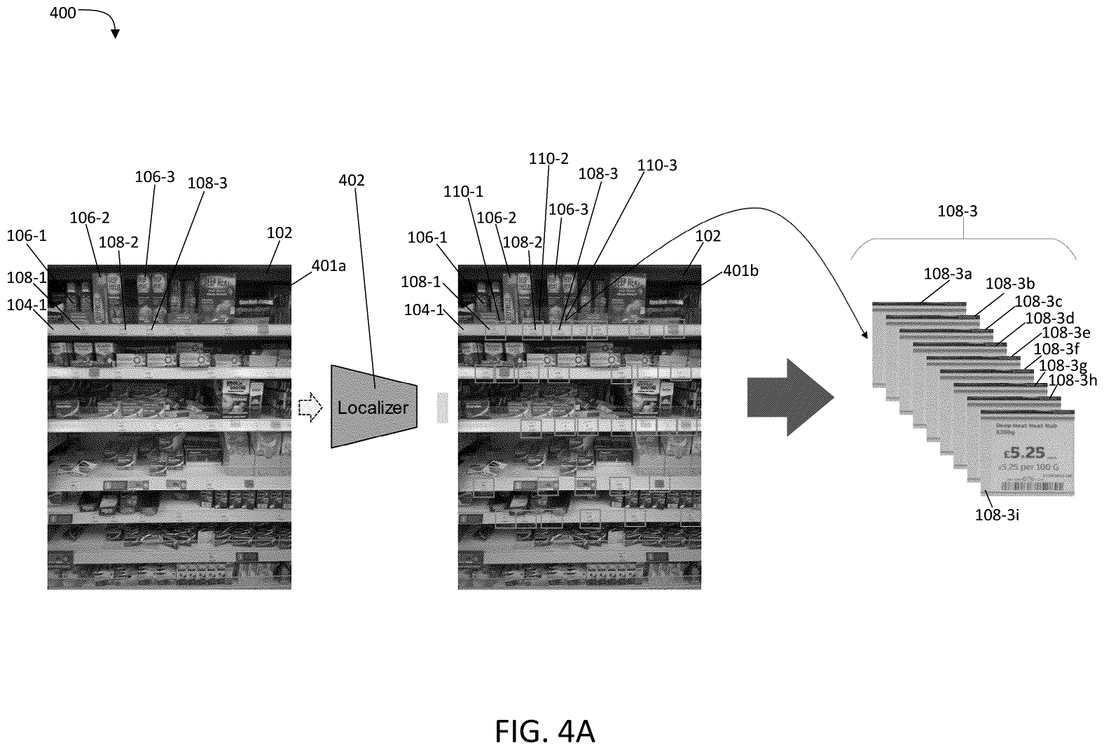

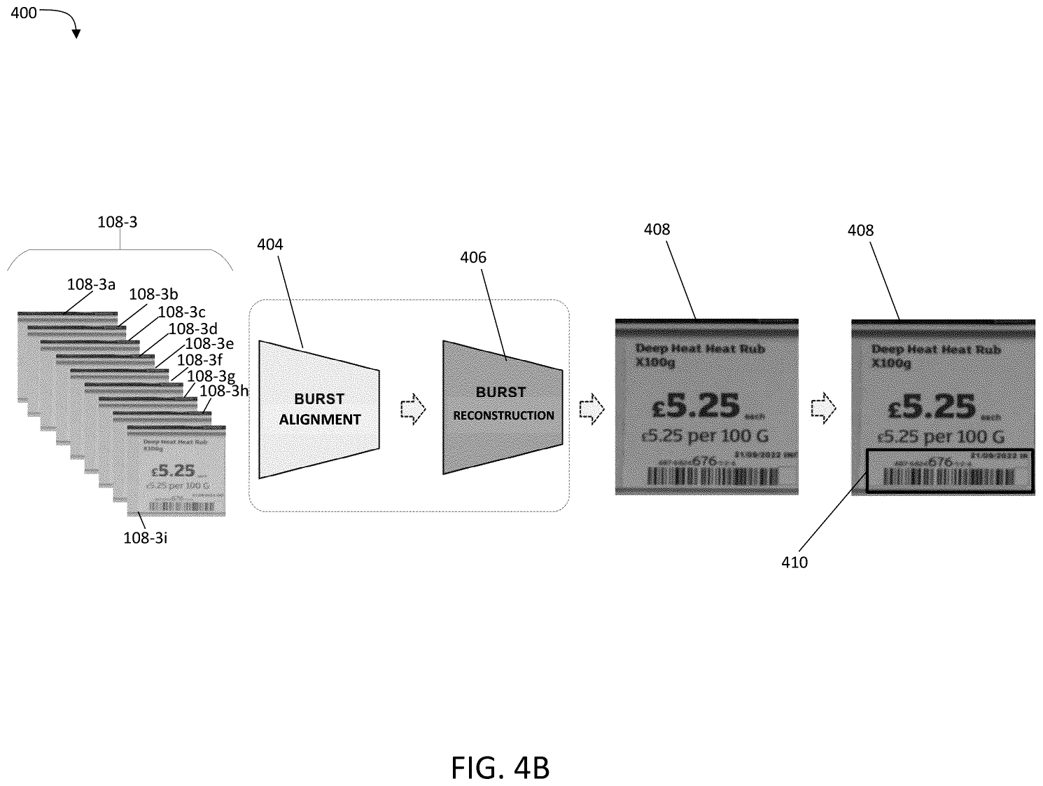

FIG. 4A is a diagram 400 illustrating processing steps 302-306 of FIG. 3 carried out by an embodiment of the present disclosure. As shown in FIG. 4A, the system applies a localizer 402 to a first image 401a of a burst of low resolution images to detect at least one attribute (e.g., a shape, a color, a pattern, a logo, a size, a width, a length, a height, and a label 108) of the display module 102 and/or an item 106 positioned thereon present in the first image 401a of the burst of images. The first image 401a includes a display module 102 having at least one support surface 104-1 on which items 106-1, 106-2, and 106-3 are positioned thereon. Items 106-1, 106-2 and 106-3 can be respectively identified by item labels 108-1, 108-2 and 108-3. The label 108 can depict at least one of a barcode (e.g., a SKU and/or a UPC), a feature and/or text (e.g., a price).

The system, based on the application of the localizer 402 to the first image 401a, can generate a processed first image 401b having coordinates (e.g., a bounding box) associated with at least one attribute of the display module 102 and/or item 106 positioned thereon present in the first image 401a of the burst of images. For example, the processed first image 401b further includes bounding boxes 110-1, 110-2, and 110-3 (collectively referred to as bounding boxes 110, and generically referred to as bounding box 110) respectively associated with item labels 108-1, 108-2 and 108-3. The system can extract the at least one attribute of the display module 102 and/or item 106 present in the processed first image 401b from each image of the burst of images. For example, the system can utilize the bounding box 110-3 to extract (e.g., crop) the label 108-3 present in the processed image 401b from each image of the burst of images to yield a plurality of labels 108-3a-i.

Returning to FIG. 3, in step 308, the system aligns the extracted at least one attribute from each image of the burst of images with the extracted at least one attribute of the first image. For example, the system can align (e.g., register) each extracted label 108 of the burst of images to the extracted label 108 of the first image according to subpixel precision to align the at least one attribute of the burst of images. In step 310, the system generates a reconstructed image based on the aligned at least one attribute of the burst of images. For example, the system applies a multi-stage super resolution (SR) transformer network to the aligned at least one attribute of the burst of images to generate a reconstructed (e.g., a super resolved) image. The multi-stage SR transformer network provides for at least one of denoising, fusion, demosaicing and reconstruction. A resolution of the reconstructed image can be two to eight times greater than a resolution of the first image based on at least one of a distance between a display module 102 and a device 116 and a resolution of a camera 210 of the device 116.

Then, in step 312, the system detects at least one attribute present in the reconstructed image. For example, the system can detect at least one attribute (e.g., a barcode, feature and/or text) present in the reconstructed image by applying at least one of a non-transitory computer-readable medium barcode reader and a deep learning model to the reconstructed image. In this way, the system can detect the at least one attribute present in the reconstructed image with sufficient detail because the resolution of the reconstructed image is greater than the resolution of the burst of images such that a barcode, feature and/or text can contain more granular details. For example, these granular details can provide for a barcode to be visible and readable by the at least one of the non-transitory computer-readable medium barcode reader and the deep learning model. In another example, these granular details can provide for facilitating barcode, feature and/or text detection (e.g., recognition) and extraction when the barcode, feature, and/or text is damaged.

FIG. 4B is a diagram 400 illustrating processing steps 308-312 of FIG. 3 carried out by an embodiment of the present disclosure. As shown in FIG. 4B, the system applies burst alignment 404 to the plurality of item labels 108-3 to align the extracted at least one attribute from each image of the burst of images with the extracted at least one attribute of the first image. For example, the system can align (e.g., register) each extracted label 108-3b-i of the burst of images to the extracted label 108-3a of the processed first image 401b according to subpixel precision to align the at least one attribute of the burst of images. The system applies burst reconstruction 406 to the aligned at least one attribute of the burst of images to generate a reconstructed image 408. For example, the system applies a multi-stage SR transformer network to the aligned at least one attribute of the burst of images to generate a reconstructed (e.g., a super resolved) image 408. A resolution of the reconstructed image 408 can be two to eight times greater than a resolution of the processed first image 401b based on at least one of a distance between a display module 102 and a device 116 and a resolution of a camera 210 of the device 116. The system can detect at least one attribute present in the reconstructed image 408. For example, the system can detect at least one attribute 410 (e.g., a barcode, feature and/or text) present in the reconstructed image 408 by applying at least one of a non-transitory computer-readable medium barcode reader and a deep learning model to the reconstructed image 408.

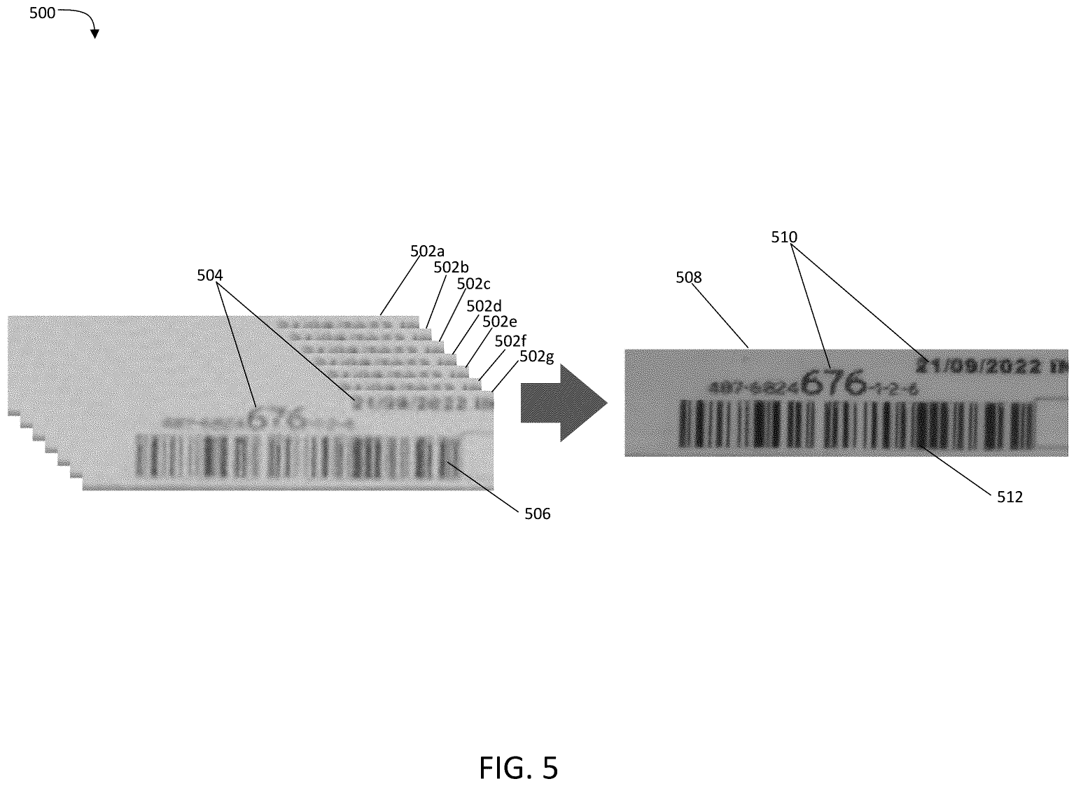

FIG. 5 is a diagram 500 illustrating portions 502a-g of an extracted at least one attribute of an object present in a burst of images and a portion 508 of a reconstructed image based on the extracted and aligned at least one attribute of the burst of images. For example, FIG. 5 illustrates portions 502a-g depicting text 504 (e.g., a date and product number) and a barcode 506 of the extracted and aligned label 108-3 of the display module 102 from FIGS. 4A-B. As shown in FIG. 5, the portion 508 of the reconstructed image is of greater resolution than the portions 502a-g such that the text 510 and barcode 512 of the portion 508 include greater granular details (e.g., the portion 508 is clearer). As mentioned above, the system can detect at least one attribute (e.g., a barcode, feature and/or text) present in a reconstructed image with sufficient detail because a resolution of the reconstructed image is greater than a resolution of a burst of images such that a barcode, feature and/or text can contain more granular details. For example, these granular details can provide for a barcode to be visible and readable by at least one of a non-transitory computer-readable medium barcode reader and a deep learning model. In another example, these granular details can provide for facilitating barcode, feature and/or text detection (e.g., recognition) and extraction when the barcode, feature, and/or text is damaged.

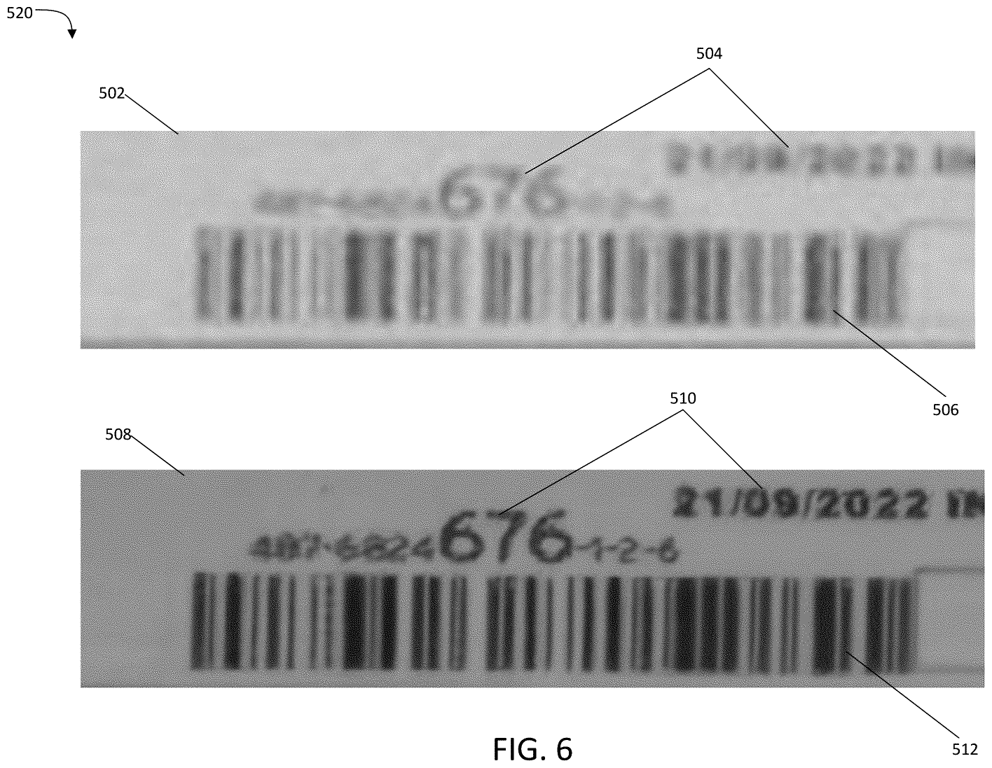

FIG. 6 is a diagram 520 illustrating a comparison of a portion 502 (e.g., one of portions 502a-g of FIG. 5) of an extracted at least one attribute of an object present in a burst of images and a portion 508 of a reconstructed image. As shown in FIG. 6, the portion 508 of the reconstructed image is of greater resolution than the portions 502 such that the text 510 and barcode 512 of the portion 508 include greater granular details (e.g., the portion 508 is clearer than the portion 502). As mentioned above, a resolution of a reconstructed image can be two to eight times greater than a resolution of an image of a burst of images based on at least one of a distance between a display module 102 and a device 116 and a resolution of a camera 210 of the device 116.

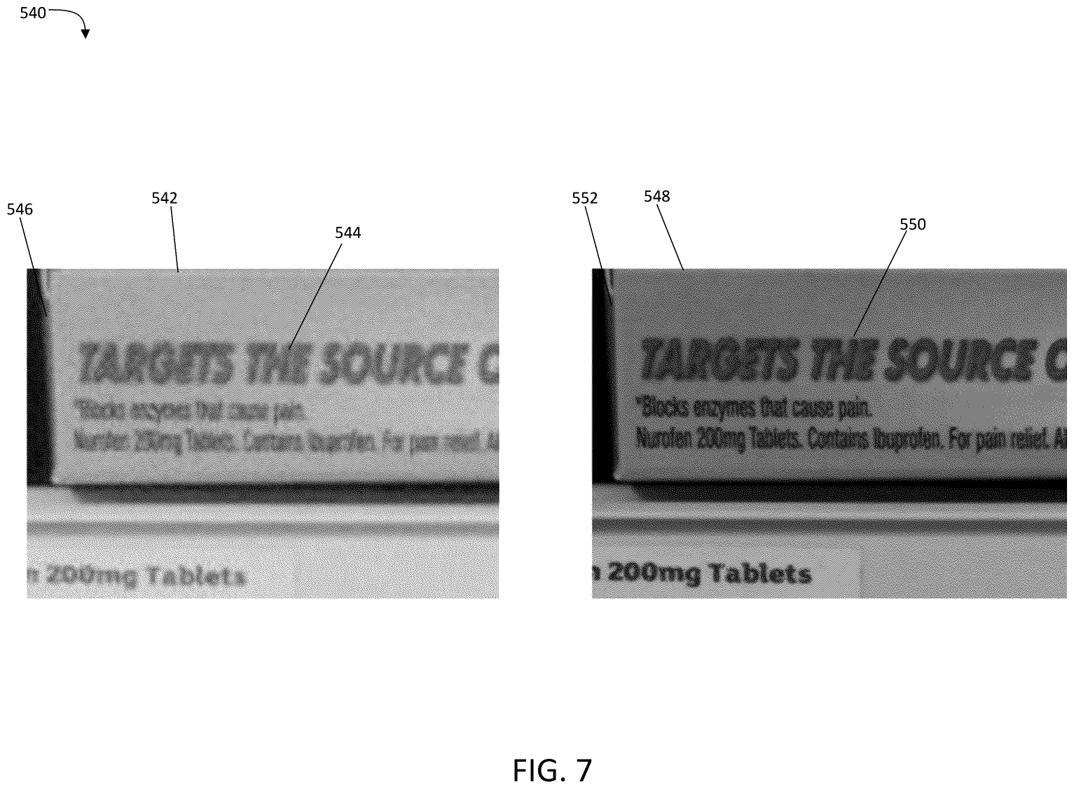

FIG. 7 is a diagram 540 illustrating a comparison of a portion 542 of an extracted at least one attribute (e.g., text 544) of an object (e.g., an item 546) present in a burst of images and a portion 548 of at least one attribute (e.g., text 550) of an object (e.g., item 552) present in a reconstructed image. As shown in FIG. 7, the portion 548 of the reconstructed image is of greater resolution than the portions 542 such that the text 550 of the portion 548 includes greater granular details. As mentioned above, a resolution of a reconstructed image can be two to eight times greater than a resolution of an image of a burst of images based on at least one of a distance between a display module 102 and a device 116 and a resolution of a camera 210 of the device 116.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A method, comprising:
capturing a burst of images of at least a portion of an object, the object being a display module for displaying at least one item;
detecting at least one attribute of the object present in a first image of the burst of images;
extracting the at least one attribute of the object present in the first image from each image of the burst of images;
aligning the extracted at least one attribute from each image of the burst of images with the extracted at least one attribute of the first image; and
generating a reconstructed image based on the aligned at least one attribute of the burst of images,
wherein the resolution of the first image is different from the resolution of the reconstructed image.

2. The method of claim 1, wherein
the object comprises at least one support surface, the at least one support surface being at least one of a shelf, a rack, a bay, and a bin for displaying the at least one item, and
the at least one attribute of the object present in the first image is a label associated with the at least one item.

3. The method of claim 1, wherein the resolution of the reconstructed image is two to eight times greater than the resolution of the first image.

4. The method of claim 1, wherein detecting the at least one attribute of the object present in the first image of the burst of images comprises:
applying a localizer to the first image; and
generating bounding box coordinates associated with the detected at least one attribute of the object present in the first image.

5. The method of claim 1, wherein generating the reconstructed image based on the aligned at least one attribute of the burst of images comprises applying a super resolution transformer network to the aligned at least one attribute of the burst of images.

6. The method of claim 1, further comprising detecting at least one attribute present in the reconstructed image, wherein the at least one attribute is at least one of a barcode, a feature and text.

7. The method of claim 6, wherein detecting the at least one attribute present in the reconstructed image comprises applying at least one of a non-transitory computer-readable medium barcode reader and a deep learning model to the reconstructed image.

8. A device, comprising:
an imaging assembly configured to capture a burst of images of at least a portion of an object, the object being a display module for displaying at least one item;
one or more processors; and
a non-transitory computer-readable memory coupled to the imaging assembly and the one or more processors, the memory storing instructions thereon that, when executed by the one or more processors, cause the one or more processors to:
detect at least one attribute of the object present in a first image of the burst of images,
extract the at least one attribute of the object present in the first image from each image of the burst of images,
align the extracted at least one attribute from each image of the burst of images with the extracted at least one attribute of the first image, and
generate a reconstructed image based on the aligned at least one attribute of the burst of images,
wherein the resolution of the first image is different from the resolution of the reconstructed image.

9. The device of claim 8, wherein
the object comprises at least one support surface, the at least one support surface being at least one of a shelf, a rack, a bay, and a bin for displaying the at least one item, and
the at least one attribute of the object present in the first image is a label associated with the at least one item.

10. The device of claim 8, wherein the resolution of the reconstructed image is two to eight times greater than the resolution of the first image.

11. The device of claim 8, wherein the instructions, when executed, cause the one or more processors to detect the at least one attribute of the object present in the first image of the burst of images by:
applying a localizer to the first image, and
generating bounding box coordinates associated with the detected at least one attribute of the object present in the first image.

12. The device of claim 8, wherein the instructions, when executed, cause the one or more processors to generate the reconstructed image based on the aligned at least one attribute of the burst of images by applying a super resolution transformer network to the aligned burst of images.

13. The device of claim 8, wherein the instructions, when executed, further cause the one or more processors to detect at least one attribute present in the reconstructed image, the at least one attribute being at least one of a barcode, a feature and text.

14. The device of claim 13, wherein the instructions, when executed, cause the one or more processors to detect the at least one attribute present in the reconstructed image by applying at least one of a non-transitory computer-readable medium barcode reader and a deep learning model to the reconstructed image.

15. A system, comprising:
at least one device having an imaging assembly configured to capture a burst of images of at least a portion of an object, the object being a display module for displaying at least one item;
a server having one or more processors; and
a non-transitory computer-readable memory coupled to the server and the one or more processors, the memory storing instructions thereon that, when executed by the one or more processors, cause the one or more processors to:
detect at least one attribute of the object present in a first image of the burst of images,
extract the at least one attribute of the object present in the first image from each image of the burst of images,
align the extracted at least one attribute from each image of the burst of images with the extracted at least one attribute of the first image, and
generate a reconstructed image based on the aligned at least one attribute of the burst of images,
wherein the resolution of the first image is different from the resolution of the reconstructed image.

16. The system of claim 15, wherein
the object comprises at least one support surface, the at least one support surface being at least one of a shelf, a rack, a bay, and a bin for displaying the at least one item,
the at least one attribute of the object present in the first image is a label associated with the at least one item, and
the resolution of the reconstructed image is two to eight times greater than the resolution of the first image.

17. The system of claim 15, wherein the instructions, when executed, cause the one or more processors to detect the at least one attribute of the object present in the first image of the burst of images by:
applying a localizer to the first image, and
generating bounding box coordinates associated with the detected at least one attribute of the object present in the first image.

18. The system of claim 15, wherein the instructions, when executed, cause the one or more processors to generate the reconstructed image based on the aligned at least one attribute of the burst of images by applying a super resolution transformer network to the aligned burst of images.

19. The system of claim 15, wherein the instructions, when executed, further cause the one or more processors to detect at least one attribute present in the reconstructed image, the at least one attribute being at least one of a barcode, a feature and text.

20. The system of claim 19, wherein the instructions, when executed, cause the one or more processors to detect the at least one attribute present in the reconstructed image by applying at least one of a non-transitory computer-readable medium barcode reader and a deep learning model to the reconstructed image.
